(19) United States
(12) Patent Application Publication
(10) Pub. No.: US 2007/0264238 A1
(43) Pub. Date: Nov. 15, 2007

(54) Procedure to regenerate articular cartilage in human advanced osteoarthritis using autologous hematopoetic stem cell transplantation

(76) Inventors: Robert A. Shaw, Sparks, MD (US); Florin I. Niculescu, Sykesville, MD (US)

Correspondence Address: OBER|KALER, 120 East Baltimore Street, Baltimore, MD, 21202-1643, US

(21) Appl. No.: 11/430,450

(22) Filed: May 9, 2006

(51) Int. Cl. A01N 63/00

(52) U.S. Cl. 424/93.7

(57) ABSTRACT

A procedure for regenerating cartilage in a patient's joint damaged by Osteoarthritis by transplanting autologous hematopoetic stem cells extracted from a human, preferably the same human. The procedure begins by screening to ensure that the patient is a suitable candidate, then preparation of the patient for the stem cell transplantation by a combined regimen of intra-articular injection to diminish inflammation and facilitate apoptotic cell clearance, plus subcutaneous injection of hematopoetic growth factor. The autologous hematopoetic stem cells are then purified by incubating a blood sample with magnetic polystyrene beads (Dynabeads™) coated with a monoclonal antibody specific for CD34 cell membrane antigen. The stem cells are separated from the blood sample using a magnetic particle separator, and washed through a plurality of washing substeps. The purified and separated stem cells are suspended in a particular transplant solution, and the transplant solution is injected into the patient's joint such that the purified and separated autologous hemotopoetic stem cells enter the patient's damaged joint, and regenerates. The transplant solution contains specific growth factors that direct the stem cells into the areas of damaged or absent cartilage, allowing the stem cells to differentiate into young chondrocytes. This produces new healthy cartilage with a high potential in restoring the integrity and functionality of the joint.

### BACKGROUND

a. Field of Invention

The invention relates to treatment for osteoarthritis and, more particularly, to a procedure to regenerate cartilage in humans damaged by osteoarthritis by transplanting autologous hematopoetic stem cells.

b. Background of the Invention

Osteoarthritis (OA) is the leading cause of physical disability, increased health care utilization and costs, as well as a substantially impaired quality of life, in our modern, industrialized society. More than 56 millions Americans suffer from this condition today, and this is a number much larger than all the patients with diabetes, cancer, HIV/AIDS and hypertension taken together. Moreover, the impact of this arthritic condition is expected to grow with both the population increase and its aging during the coming decades. See, for example, Brandt et al., Osteoarthritis, in “Prognosis in the Rheumatic Diseases”, ed. N. Bellamy. Kluwer Academic Publishers: Lancaster, UK (1991); Moskowitz et al. “Osteoarthritis: Diagnosis and Management”, WB Saunders, Philadelphia (1984); Huch K et al., “Osteoarthritis in ankle and knee joints”, Semin Arthritis Rheum, 26(4): 667 (1997).

OA was thought in the past to be a normal consequence of aging, therefore considered a “degenerative joint disease.” Now, however, we realize that OA results from a multi-factorial pathogenesis, affecting the joint integrity including aging itself, trauma or other mechanical forces, a certain genetic predisposition, a local inflammation associated to the late stages of cartilage degeneration, as well as a complex cellular and biochemical process. van Saase, J L et al., “Epidemiology of osteoarthritis”; Zoetermeer, Survey: Comparison of radiological osteoarthritis in a Dutch population with that in 10 other populations”, Ann Rheum Dis; 48:271 (1989); Doherty et al., “Epidemiology of peripheral joint arthritis”, Ann Rheum Dis. 55:585 (1996); Solomon, L., “Clinical features of osteoarthritis. In: “Textbook of Rheumatology”, Kelley, W N, Hams, E D Jr, Ruddy S, Sledge C B (Eds), WB Saunders, Philadelphia (1996).

Despite an extensive prevalence and a very heterogenous pathogenesis, only in part understood today, the progression of OA remains largely beyond explanation, due in part to multiple factors including our inability to detect the early phase of the disease, as well as the lack of appropriate procedures to replace the damaged cartilage. The cartilage injury appears during the early stages. However complete cartilage loss occurs in the late stages of the disease and this becomes the cause of the joint impairment. Existing treatments for joint impairment include osteochondral allografting. This procedure involves the transplantation of a piece of articular cartilage and attached subchondral bone from a cadaver donor to a damaged region of the articular surface of a joint. The goal is to provide viable chondrocytes and supporting bone that will be sufficient to maintain the cartilage matrix and thereby relieve pain and reduce further damage to the articular surface of the joint. Alternatives to osteochondral allografting include abrasion chondroplasty, osteotomy and total knee replacement, arthrodesis (fusion) or prosthetic arthroplasty of the ankle.

It would be much more advantageous to provide an approach for re-growing normal healthy cartilage in advanced osteoarthritic joints, thereby improving the chances of a prolonged life and functionality of the joint. Indeed, regeneration of cartilage in advanced osteoarthritic joints may eventually become a total cure to OA. Consequently, there is a renewed research interest in the area. See, for example, Hulth et al., “Mitosis in human osteoarthritic cartilage”, Clin Orthop 88:247 (1972); Ryu J et al., “Biochemical and metabolic abnormalities in normal and osteoarthritic human articular cartilage”, Arthritis Rheum 27:49 (1984); Lippiello et al., “Collagen synthesis in normal and osteoarthritic human cartilage”, J Clin Invest 59:593 (1973); Kempson G. E., “Age-related changes in the tensile properties of human articular cartilage: A comparative study between the femoral head of the hip joint and the talus of the ankle joint”, Biochim Biophys Acta, 075(3): 223 (1991).

In addition, U.S. Pat. No. 5,368,051 by Dunn et al. issued Nov. 29, 1994 shows a method of regenerating articular cartilage by exposing the joint having a cartilage defect, debriding the entire cartilage layer to the underlying bone-cartilage interface (to thereby expose a plurality of vascular sinusoids in the sub-chondral layer of bone adjoining the joint surface), restoring the smooth contour and topography of the joint to its natural state, surgically closing the joint, and injecting a single dosage of a mixture of purified growth hormone (somatotropin) and buffer solution into the joint to initiate the regenerative process. However, the Dunn et al. method is specifically adapted to initiate natural regeneration of articular cartilage on the joint surface using surgery followed by injection of purified growth hormone (somatotropin).

It would be greatly advantageous to provide a non-invasive procedure that relies on a transplant solution of specific growth factors to direct stem cells into the areas of damaged or absent cartilage, by intergrin receptor-tissue matrix interaction, thereby seeding the stem cells in the areas denuded of cartilage, and allowing the stem cells to differentiate into young chondrocytes under the influence of the below mentioned cocktail of specific growth factors, which keeps the cells active, producing new healthy cartilage with high potential in restoring the integrity and functionality of the joint. Accordingly, the method of the present invention provides a much needed improvement in the treatment and elimination of ailments associated with the deterioration or destruction of the articular cartilage of a joint.

### SUMMARY OF THE INVENTION

It is, therefore, an object of the present invention to provide a procedure to regenerate cartilage in humans damaged by osteoarthritis by transplanting autologous hematopoetic stem cells.

It is another object to provide a procedure to regenerate cartilage in humans as above using stem cells obtained from the same patient's peripheral blood.

It is another object to provide a procedure to regenerate cartilage in humans as above that fosters the appropriate conditions of the damaged cartilage, the presence of the adequate growth factors and matrix proteins, so that the stem cells differentiate into young chondrocytes producing new healthy cartilage.

It is still another object to stop the inflammatory process of osteoarthritis, the pain associated to this condition, and to restore full joint mobility and function.

According to the present invention, the above-described and other objects are accomplished by providing a procedure for regenerating cartilage in a patient's joint damaged by Osteoarthritis by transplanting autologous hematopoetic stem cells extracted from the same human undergoing the transplant. The procedure generally comprises the steps of: ensuring that the patient is a suitable candidate for stem cell transplantation by precise screening, preparing the patient for the stem cell transplantation by a combined regimen of intra-articular injections to diminish inflammation and facilitate apoptotic cell clearance, plus subcutaneous injections of hematopoetic growth factor, purifying autologous hemotopoetic stem cells for transplantation by incubating a blood sample with magnetic polystyrene beads (such as Dynabeads™) coated with a monoclonal antibody specific for CD34 cell membrane antigen, separating the autologous hemotopoetic stem cells from the blood sample using a magnetic particle separator, and washing the separated autologous hemotopoetic stem cells through a plurality of washing substeps. The purified and separated stem cells are suspended in a transplant solution comprising 2 ml of sterile normal saline containing 200 micrograms of human purified fibronectin, 100 micrograms of human purified beta-FGF1,100 micrograms of human purified IGF-1 and 100 micrograms of human purified TGF-beta 1. Finally, the transplant solution is injected into the patient's joint such that the purified and separated autologous hemotopoetic stem cells enter the patient's damaged joint, and regenerate. The transplant solution of specific growth factors directs the stem cells into the areas of damaged or absent cartilage, allowing the stem cells to differentiate into young chondrocytes under the influence of the above mentioned cocktail of specific growth factors, which keeps the cells active, producing new healthy cartilage with high potential in restoring the integrity and functionality of the joint. This provides a vast improvement in the treatment and elimination of ailments associated with the deterioration or destruction of the articular cartilage of a joint.

### BRIEF DESCRIPTION OF THE DRAWINGS

Additional aspects of the present invention will become evident upon reviewing the embodiments described in the specification and the claims taken in conjunction with the accompanying figures, wherein like numerals designate like elements, and wherein:

FIG. 1 is a block diagram of the generalized steps involved in the procedure to regenerate cartilage according to the present invention

FIG. 2 is a block diagram illustrating these substeps of step 4 in FIG. 1.

### DETAILED DESCRIPTION OF THE PREFERRED EMBODIMENT

The present invention is a procedure to regenerate cartilage in a human damaged by osteoarthritis by transplanting autologous hematopoetic stem cells from the same human subject.

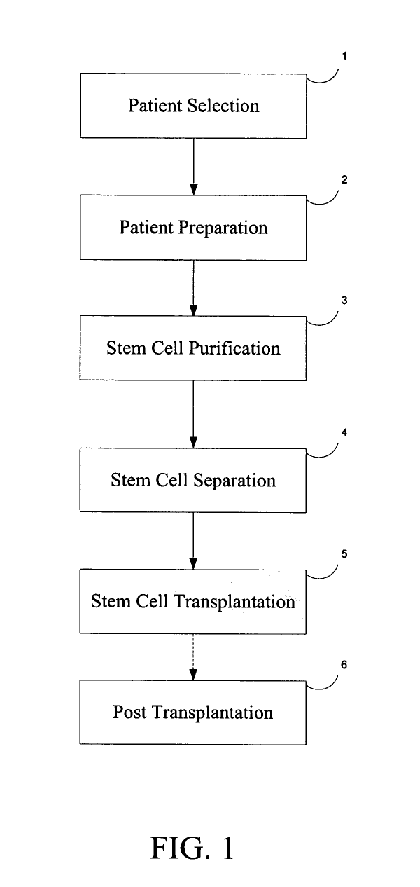

FIG. 1 is a block diagram of the generalized steps involved in the procedure to regenerate cartilage according to the present invention, which includes the following steps: 1) Patient Selection; 2) Patient Preparation; 3) Autologous hemotopoetic stem cell (AHSC) purification; 4) Autologous hemotopoetic stem cell (AHSC) separation; 5) Autologous hemotopoetic stem cell (AHSC) Transplantation; and 6) Post-Transplant Procedure. Each of these steps is herein described in more detail and a description of the outcome is provided.

Step 1: Patient Selection

Proper patient selection entails careful screening. The patient candidate for the present procedure should conform to a medical profile with the following aspects: A) patient should have medium to advanced (stages II to IV) OA; B) patient should have medium/advanced cartilage damage which cannot be repaired by the normal physiological mechanisms of cartilage repair functioning in young adults; C) the patient's cartilage damage can be readily evaluated by standard diagnostic techniques like X-rays, ultrasonography or MRI.

A. Chondrocyte numbers in healthy cartilage decrease significantly with advancing age. See, Bobacz et al., “Chondrocyte number and proteoglycan synthesis in the aging and osteoarthritic human articular cartilage”, Ann Rheum Dis 2004; 63:1618; Buckwalter J A, “Aging, articular cartilage chondrocyte senescence and osteoarthritis”, Biogerontology, 2002, 3(5):257. Chondrocytes from healthy and osteoarthritic joints synthesized comparable amounts of cartilage macromolecules, independent of age or underlying osteoarthritic disease. Thus the decrease in chondrocyte number in aging and osteoarthritic joints is a crucial factor in limiting cartilage regeneration.

B. The patient should have medium/advanced cartilage damage which cannot be repaired by the normal physiological mechanisms of cartilage repair functioning in young adults. There are natural treatments that can combat OA and significantly relieve pain, perhaps to an acceptable level. For example, weight loss may reduce biomechanical stress on weight bearing joints. Exercise helps in management of OA and, in particular, resistive strengthening. For present purposes the OA should be advanced past the point of repair by these or other normal physiological mechanisms.

Assuming that a patient conforms to the above-described criteria they are appropriate candidates for AHSC transplant according to the following steps.

Step 2: Patient Preparation

Patient Preparation involves a number of substeps including A) an intra-articular injection to diminish any existing inflammation associated with the OA and to facilitate the apoptotic cell clearance, and then, B) a single subcutaneous injection of hematopoetic growth factor which will increase the number of AHSC in circulation the day of the transplant.

A. Intra-Articular Injection

Ten days prior to the transplantation the patient to be the subject of AHSC transplant for the cartilage regeneration in a major axial joint (knee, hip, ankle, shoulder) will first have an intra-articular injection of the respective damaged joint with Depo-Medrol™ with Lidocaine. Depo-Medrol™ with Lidocaine is a known local anti-inflammatory and anaesthetic substance recommended for intra-articular and intrabursal injection. It is commercially available in measured dosages as follows (per mL):

| | |
|---|---|
| Methylprednisolone acetate | 40 mg |
| Lidocaine hydrochloride | 10 mg |

Alternatively, the Depo-Medrol™ and Lidocaine can be mixed separately, preferably

40 mg Depo-Medrol and 1 ml of 1% Lidocaine. Methylprednisolone is an anti-inflammatory steroid that inhibits the early phenomena of the inflammatory process (edema, fibrin deposition, capillary dilation, migration of phagocytes into the inflamed area and phagocytic activity), and also the later manifestations (capillary proliferation, fibroblast proliferation, deposition of collagen, and still later, cicatrization). Lidocaine is a potent anaesthetic agent widely used both for topical and injection anaesthesia. Lidocaine prevents both the generation and the conduction of the nerve impulse. The combination anti-inflammatory/anaesthetic administered 10 days in advance diminishes the inflammatory component associated to OA and facilitates the apoptotic cell clearance from the damaged cartilage.

B. At 48 hours before the procedure, the patient will receive a low-dose subcutaneous injection of Filgrastim. 20 micrograms/kg Filgrastim is presently preferred. Filgrastim is a hematopoetic growth factor which will increase the number of autologous hemotopoetic stem cell (AHSC) in circulation the day of the transplant. Filgrastim is produced by recombinant DNA technology, and NEUPOGEN® is the Amgen Inc. trademark for Filgrastim. Studies have shown that administration of Filgrastim exerts a stimulatory effect that results in an increase in circulating CD34+ cells. Rackoff W R et al., “Prolonged administration of granulocyte colony-stimulating factor (filgrastim) to patients with Fanconi anemia: a pilot study”; Blood 88(5): 1588-93 (Sep. 1, 1996). There are no known side effects described for such subcutaneous injections at this low dose and these are standard procedures for treatment of anemia in a hematology practice (id). After the above mentioned preparation, the patient will undergo the stem cell collection and AHSC transplant in the damaged joint.

Step 3: Autologous Hemotopoetic Stem Cell (AHSC) Purification

During the day of the AHSC transplant the patient will have a 50 ml fresh peripheral venous blood prelevation under regular sterile conditions of blood drawing. The freshly obtained blood will be immediately processed for the CD34 positive stem cells (AHSC) purification, using a commercially available kit provided by Dynal™ (Dynal Biotech ASA, Oslo, Norway: Prod. No. 113.01: DYNAL CD34 PROGENITOR CELL SELECTION SYSTEM). Dynabeads® M-450 CD34 are uniform, super-paramagnetic, polystyrene beads coated with a monoclonal antibody (mAb) specific for the CD34 cell membrane antigen. See, D. R. Sutherland et al., The CD34 Antigen: Structure, Biology and Potential Clinical Applications., J. Haematother, 1992, 1:115; T. Egeland et al., “CD34 The Gateway to the Study of Lymphohematopoietic Progenitor and Leukemic Cells”, The Immunologist (1994) 2:65. The CD34 membrane antigen is a heavily glycosylated transmembrane protein expressed mainly on human hematopoetic progenitor cells. J. Tong et al., “Characterization and quantitation of primitive hematopoetic progenitor cell present in peripheral blood autografts”, Exp. Hematol. (1994) 22(10):1016. Dynabeads M-450 CD34 are supplied as a suspension of 4×10⁸ beads/ml in phosphate buffered saline (PBS) having a pH of 7.4. The 50 ml blood is mixed in a sterile plastic tube with 5 ml of this Dynabead suspension and is incubated at room temperature with gentle rotation for 30 min, on an orbital shaker. It is important to maintain a homogenous suspension between the Dynabeats and the blood. Therefore it is recommended to vortex gently the mixture for 2-3 seconds every 10 min to maintain this homogenous suspension which allows a better positive selection of the CD34 cells from the blood.

Step 4: Autologous Hemotopoetic Stem Cell (AHSC) Separation

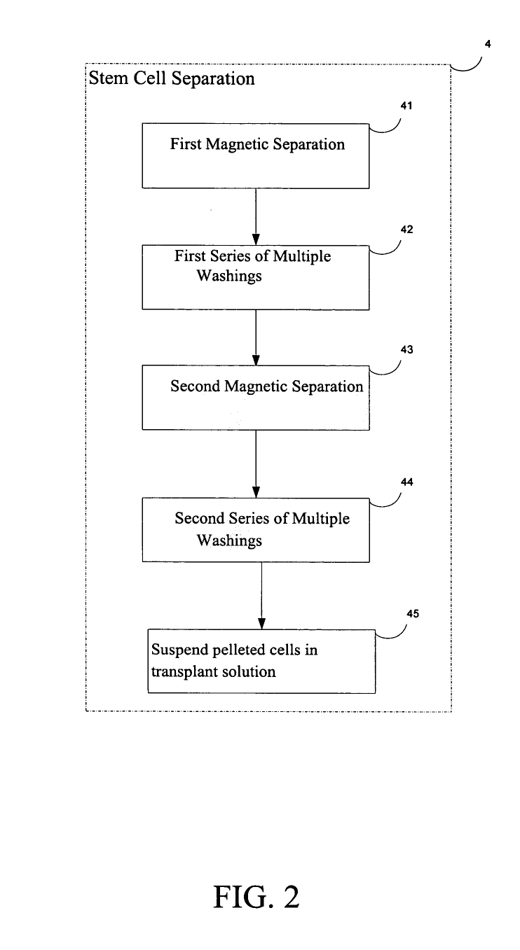

AHSC separation entails a sequence of two instances of magnetic separation, each time followed by multiple washings. FIG. 2 is a block diagram illustrating these substeps of step 4 in FIG. 1.

Substep 4. 1: First Magnetic Separation

To separate the purified CD34 stem cells from the whole blood suspension in step 3, the tube is placed on the DYNAL MPC™ (magnetic particle concentrator) for approximately 2 minutes at room temperature. The rosetted CD34+ cells will be separated from the non-targeted cells. The blood supernatant containing non-rosetted cells in serum suspension should be gently pipetted away, leaving beads undisturbed, and discarded while the tube is still exposed to the magnet (the positive CD34 cells remain attached to the magnet).

Substep 4. 2: First Series of Multiple Washings

After magnetic separation it is preferred to employ three washings of 1 min. each at room temperature using normal saline. These are performed by detaching the tube from the MPC magnet, cell homogenization (re-suspending in 10 ml sterile normal saline supernatant) and reattachment to the magnet with removal of the supernatant. After the final wash, the rosetted cells should be resuspend in 1 ml of detachment buffer (DETACHaBEAD™) and gently rotated at room temperature for 30 min on an orbital shaker. During this incubation, as previously mentioned, the cells should be in a homogenous suspension.

Substep 4. 3: Second Magnetic Separation

After this incubation, the tube will be again placed on the DYNAL MPC (magnetic particle concentrator) for 2 minutes at room temperature when the paramagnetic beads will be pelleted on the magnet and the viable CD34 stem cells will remain in suspension and will be gently collected by discarding into another sterile tube.

Substep 4. 4: Second Series of Multiple Washings

Three more washings will follow with 5 ml sterile normal saline by pelleting the cells through 1 min centrifugations at 3000 rpm for 1 min, using a table minicentrifuge, and then resuspending them again in a new fresh 5 ml normal saline.

After the last washing, at substep 4. 5, the pelleted cells will be suspended in the freshly prepared transplant solution which comprises 2 ml of sterile normal saline containing 200 micrograms of human purified fibronectin, 100 micrograms of human purified beta-FGF1, 100 micrograms of human purified IGF-1 and 100 micrograms of human purified TGF-beta 1 (Gibco BRL, Gaithersburg. Md.).

Step 5: Autologous Hemotopoetic Stem Cell (AHSC) Transplantation

To then complete the transplantation, the cells suspended in the transplant solution are injected under standard sterile conditions into the joint with OA for the cartilage re-growth using an 18 ga sterile needle. A 30 min bed rest is recommended for the patient after the procedure and 3 days of non-weight bearing of the transplanted joint. The transplant solution of containing fibronectin directs the stem cells into the areas of damaged or absent cartilage, allowing the stem cells to differentiate into young chondrocytes under the influence of the above mentioned cocktail of specific growth factors, which keeps the cells active, producing new healthy cartilage with high potential in restoring the integrity and functionality of the joint.

Step 6: Post-Transplant

A regimen of medium/low physical activity is recommended for a month after the procedure. X-rays or ultrasound examination of the transplanted joint are recommended at 1 and 3 months after the procedure to examine the re-grown cartilage. Side effects of this transplant are similar to a regular intra-articular procedure including an inflammatory reaction of 24-48 h duration including pain, redness, minor fluid collection and possible sepsis if inadequate sterile conditions are used.

Outcomes

Based on experience using this procedure as well as previously published data using growth factors in cartilage metabolism, the fibronectin from the transplant solution direct the stem cells into the areas of damaged or absent cartilage by intergrin receptor-tissue matrix interaction. See, Loeser R F et al., “Articular chondrocytes express the receptor for advanced glycation end products: Potential role in osteoarthritis”, Arthritis Rheum (2005) 52(8):2376; also, Goessler U R et al.; Differential modulation of integrin expression in chondrocytes during expansion for tissue engineering”; In Vivo (2005) 19(3):501.

The stem cells, once seeded in the area denuded of cartilage, will differentiate into young chondrocytes under the influence of the above mentioned cocktail of specific growth factors, which will keep the cells active, producing new healthy cartilage with high potential in restoring the integrity and functionality of the joint. Thus, for the first time in therapy it becomes possible to use autologous stem cells to regrow human cartilage and to restore the articular integrity and functionality. Moreover, the procedure is easy to perform, can be used in any rheumatology or orthopedic community practice, with commercially available reagents, at a low cost and very high efficiency in growing the normal healthy cartilage needed for a functional articulation.

Having now fully set forth the preferred embodiment and certain modifications of the concept underlying the present invention, various other embodiments as well as certain variations and modifications of the embodiments herein shown and described will obviously occur to those skilled in the art upon becoming familiar with said underlying concept. It is to be understood, therefore, that the invention may be practiced otherwise than as specifically set forth herein.

We claim:

1. A procedure to regenerate cartilage in a patient's joint damaged by osteoarthritis
by transplanting autologous hematopoetic stem cells extracted from a human, comprising the steps of:
ensuring that said patient is a suitable candidate for stem cell transplantation by screening;
preparing said patient for said stem cell transplantation by a combined regimen of intra-articular injections to diminish inflammation and facilitate apoptotic cell clearance, plus subcutaneous injections of hematopoetic growth factor;
purifying autologous hemotopoetic stem cells for transplantation by incubating a blood sample with a monoclonal antibody specific for CD34 cell membrane antigen;
separating autologous hemotopoetic stem cells from said blood sample in a particle separator and washing the separated autologous hemotopoetic stem cells through a plurality of washing substeps; and
transplanting the purified and separated autologous hemotopoetic stem cells into said patient's damaged joint.

2. The procedure for regenerating cartilage in a patient's joint damaged by osteoarthritis according to claim 1, wherein the human from whom said stem cells are extracted and the patient into whom said stem cells are transplanted are the same person.

3. The procedure for regenerating cartilage in a patient's joint damaged by osteoarthritis according to claim 2, wherein said step of ensuring that said patient is a suitable candidate for stem cell transplantation further comprises screening to ensure that said patient has medium to advanced stage OA, medium to advanced cartilage damage that cannot be repaired by normal healing, has a pool of chondrocytes and chondroblasts that are active, and that said patient can be evaluated by standard diagnostic techniques.

4. The procedure for regenerating cartilage in a patient's joint damaged by osteoarthritis according to claim 2, wherein said step of preparing said patient comprises administering an intra-articular injection of Depo-Medrol™ with Lidocaine at least ten days in advance of said transplant step.

5. The procedure for regenerating cartilage in a patient's joint damaged by osteoarthritis according to claim 4, wherein said Depo-Medrol™ with Lidocaine comprises approximately 40 mg Depo-Medrol and 1 ml of 1% Lidocaine.

6. The procedure for regenerating cartilage in a patient's joint damaged by osteoarthritis according to claim 4, wherein said step of preparing said patient comprises administering at least one low-dose subcutaneous injections of Filgrastim approximately 48 hours before said transplant step.

7. The procedure for regenerating cartilage in a patient's joint damaged by osteoarthritis according to claim 6, wherein said one low-dose subcutaneous injections of Filgrastim further comprise approximately 20 micrograms/kg Filgrastim.

8. The procedure for regenerating cartilage in a patient's joint damaged by
osteoarthritis according to claim 2, wherein said step of autologous hemotopoetic stem cell purification further comprises the substeps of drawing a 50 ml fresh peripheral venous blood sample under sterile conditions and introducing therein a plurality of paramagnetic, polystyrene beads coated with a monoclonal antibody specific for the CD34 cell membrane antigen, and incubating.

9. The procedure for regenerating cartilage in a patient's joint damaged by osteoarthritis according to claim 8, wherein said substep of incubating further comprises incubating at room temperature with gentle rotation for approximately 30 minutes on an orbital shaker.

10. The procedure for regenerating cartilage in a patient's joint damaged by osteoarthritis according to claim 9, wherein said gentle rotation further comprises rotating said blood sample two-to-three times every 10 min to maintain a homogenous suspension.

11. The procedure for regenerating cartilage in a patient's joint damaged by
osteoarthritis according to claim 2, wherein said step of autologous hemotopoetic stem cell separation further comprises at least two magnetic particle separations of said autologous hemotopoetic stem cells from said blood sample, each magnetic particle separation being followed by a series of multiple washings of the autologous hemotopoetic stem cells.

12. The procedure for regenerating cartilage in a patient's joint damaged by osteoarthritis according to claim 11, wherein said step of autologous hemotopoetic stem cell separation further comprises the substeps of a first magnetic particle separation of said autologous hemotopoetic stem cells from said blood sample, a first series of multiple washings of the autologous hemotopoetic stem cells, a second magnetic particle separation of said autologous hemotopoetic stem cells from said blood sample, and a second series of multiple washings of the autologous hemotopoetic stem cells.

13. The procedure for regenerating cartilage in a patient's joint damaged by osteoarthritis according to claim 12, wherein said first and second magnetic particle separation substeps are each performed on a magnetic particle concentrator for approximately 2 minutes at room temperature.

14. The procedure for regenerating cartilage in a patient's joint damaged by osteoarthritis according to claim 13, wherein said first series of washings comprises three washings of 1 minute each at room temperature in normal saline.

15. The procedure for regenerating cartilage in a patient's joint damaged by osteoarthritis according to claim 14, wherein said second series of washings comprises three washings in 5 ml sterile normal saline during 1 min centrifugations at 3000 rpm for 1 min, using a centrifuge, and then resuspending in fresh 5 ml normal saline.

16. The procedure for regenerating cartilage in a patient's joint damaged by
osteoarthritis according to claim 14, further comprising a substep after said second series of washings of suspending the autologous hemotopoetic stem cells in a transplant solution comprising 2 ml of sterile normal saline containing approximately 200 micrograms of human purified fibronectin, 100 micrograms of human purified beta-FGF 1, 100 micrograms of human purified IGF-1 and 100 micrograms of human purified TGF-beta 1.

17. The procedure for regenerating cartilage in a patient's joint damaged by osteoarthritis according to claim 16, wherein said step of transplanting said autologous hemotopoetic stem cells in said transplant solution by injection under standard sterile conditions into the patient's joint.

18. The procedure for regenerating cartilage in a patient's joint damaged by osteoarthritis according to claim 17 wherein said injection is performed using an 18 ga sterile needle.
